(19) United States
(12) Patent Application Publication
(10) Pub. No.: US 2017/0059127 A1
(43) Pub. Date: Mar. 2, 2017

(54) METHODS AND APPARATUS FOR USE IN ASSOCIATION WITH LIGHTING SYSTEMS

(71) Applicant: GE LIGHTING SOLUTIONS, LLC, East Cleveland, OH (US)

(72) Inventors: Jon Bennett JANSMA, Pepper Pike, OH (US); Jianmin HE, Orange, OH (US); Dengke CAI, Mentor, OH (US)

(21) Appl. No.: 14/842,341

(22) Filed: Sep. 1, 2015

(51) Int. Cl. F21V 9/16; G01J 3/46; F21V 7/22; F21V 7/00

(52) U.S. Cl. CPC F21V 9/16; F21V 7/0066; G01J 3/46; F21V 7/22; F21Y 2101/02

(57) ABSTRACT

In some embodiments, a method of manufacturing a lighting system comprises: coupling a light source to a reflector, the reflector including a substrate having a first side configured to face toward the light source; and disposing an organic phosphor layer on the first side of the substrate. In some embodiments, a method comprises: determining target color characteristics for light produced by a lighting system of a first type; for each one of a plurality of lighting systems of the first type: (a) measuring color characteristics of light produced by the one of the plurality of lighting systems; (b) determining characteristics of a phosphor layer to be disposed on a reflector of the one of the plurality of lighting systems; and (c) disposing a phosphor layer having the determined characteristics on the reflector of the one of the plurality of lighting systems.

### FIELD

Embodiments of the present disclosure relate generally to methods and apparatus for use in association with lighting systems.

### BACKGROUND

Many light emitting diode (LED) lighting applications start with a blue LED as a light source. Green and/or yellow phosphors can be added to such a light source to result in what is referred to as a “blue shifted yellow” (BSY) light source. A BSY light source, although often considered to provide a form of white light, provides light having blue and yellow (or green) radiation peaks.

If improved white light is desired, a red LED can be added to a BSY light source to result in what is referred to as a “blue shifted yellow plus red” (BSY+R) light source. A BSY+R light source produces wavelengths of light that mix together to produce white light having improved color rendering characteristics relative to a BSY light source without added red light.

However, the addition of a red LED to a BSY light source requires the use of more expensive LED drivers, which may increase the overall cost of the light source.

### BRIEF DESCRIPTION

In a first aspect, a lighting system comprises: a light source and a reflector. The reflector includes a substrate having a first side configured to face toward the light source and an organic phosphor layer disposed on the first side.

In some embodiments, the organic phosphor layer comprises organic red phosphor. In some embodiments, the organic phosphor layer comprises: organic phosphor; and reflective material.

In some embodiments, the organic phosphor layer receives a portion of the light from the light source and emits light that mixes with other portions of the light from the light source. In some embodiments, the mixing results in white light.

In a second aspect, a method of manufacturing a lighting system comprises: coupling a light source to a reflector, the reflector including a substrate having a first side configured to face toward the light source; and disposing an organic phosphor layer on the first side of the substrate.

In a third aspect, a method comprises: determining target color characteristics for light produced by a lighting system of a first type; for each one of a plurality of lighting systems of the first type: (a) measuring color characteristics of light produced by the one of the plurality of lighting systems; (b) determining characteristics of a phosphor layer to be disposed on a reflector of the one of the plurality of lighting systems based on: (1) the determined target color characteristics for light produced by a lighting system of the first type and (2) the measured color characteristics of the light produced by the one of the plurality of lighting systems; and (c) disposing a phosphor layer having the determined characteristics on the reflector of the one of the plurality of lighting systems.

### BRIEF DESCRIPTION OF THE DRAWINGS

FIG. 1 is a cross-sectional view of a lighting system, in accordance with some embodiments.

FIG. 2A is an enlarged cross-sectional view of a reflector in the lighting system, in accordance with some embodiments.

FIG. 2B is an enlarged cross-sectional view of a reflector in the lighting system, in accordance with some embodiments.

FIG. 3 is a flow chart of a method, in accordance with some embodiments.

FIG. 4 is a block diagram of an architecture 400 according to some embodiments.

### DETAILED DESCRIPTION

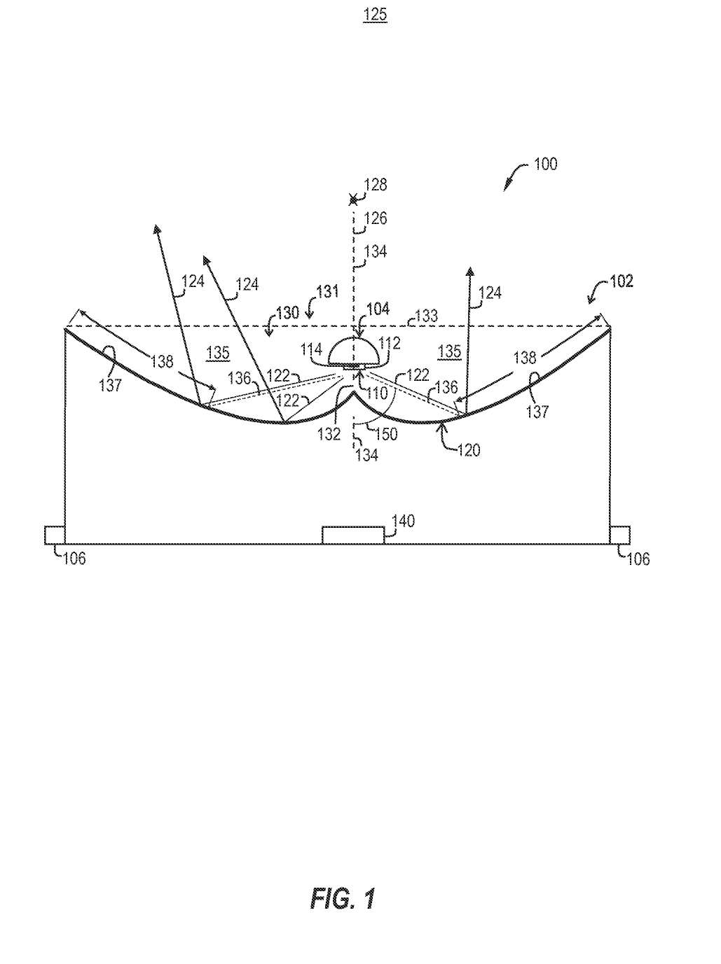

FIG. 1 is a cross-sectional view of a lighting system 100, in accordance with some embodiments. Referring to FIG. 1, the lighting system 100 includes a fixture 102 and a light source 104 coupled thereto.

The fixture 102 may include one or more structures, e.g., flanges 106, for mounting or otherwise coupling the lighting system 100 to a support (e.g., a beam in a ceiling above a room to be occupied by a person and illuminated by the lighting system 100).

The light source 104 may include one or more LED packages 110, each of which may include a case, e.g., case 112, and one or more LEDs, e.g., LED 114, mounted or otherwise disposed therein. In some embodiments, the light source 104 comprises a plurality of BSY LED packages or a combination of blue LED packages and BSY LED packages. If the light source 104 includes a plurality of LED packages 110, the LED packages 110 may be disposed in a strip or other configuration. In some embodiments, the light source 104 is a medium or high power light source and is mounted or otherwise coupled to a heatsink or other structure on the fixture 102.

The fixture 102 includes a reflector 120 to receive light, e.g., indicated by light rays 122, from the light source 104, and to reflect light, e.g., indicated by light rays 124, in one or more directions. In some embodiments, the reflected light 124 is directed toward an area 125 (e.g., a room) to be occupied by a person and illuminated by the lighting system 100.

The reflector 120 may have any suitable configuration. In some embodiments, the reflector 120 will have a generally cylindrical and/or parabolic shape disposed about a radial axis 126. In some other embodiments, the reflector 120 will have a generally parabolic cross section and radial axis 126 in a first direction and an elongated cross section and longitudinal axis (represented by an arrow 128 pointing into the page) in a second direction.

Regardless of the configuration, the reflector 120 may define a cavity 130, which receives the light from the light source 104, and may further define an opening 131, which allows light from within the cavity 130 to be transmitted to an area to be illuminated by the lighting system 100. (In some embodiments, a light transmitting (transparent or translucent) cover 133 may be disposed across the opening 131.)

The cavity 130 may include a first region 132, which is near the light source 104 and receives more light from the light source 104 than does other regions in the cavity 130. If the light source 104 has an optical axis, e.g., an optical axis 134, the first region 132 may be disposed on the optical axis 134. In the first region 132, light emitted by the light source 104 may mix together. For this reason, the first region 132 is sometimes referred to as a mixing region. In some embodiments, the first region is not visible from areas, e.g., area 125, illuminated by the lighting system 100.

The cavity 130 may further include a second region 135 (shown bounded, in part, by a dashed line 136), which is remote from the light source 104 and receives significantly less light from the light source 104 than does the first region 130A. In some embodiments, the second region 135 is visible from areas, e.g., area 125, illuminated by the lighting system 100.

The lighting system 100 may further includes drive circuitry 140 coupled between the light source 104 and a power source (e.g., an AC power source, not shown). The drive circuitry 140 may be configured to receive power from the power source and to supply power to the light source 104. As pointed out above, a color of light other than that produced by the light source may be desired.

In accordance with some embodiments, an organic phosphor layer 137 may be disposed on one or more portion, e.g., portion 138, of the reflector 120 to change the color of light produced by the lighting system 100. A “phosphor” is a luminescent material that absorbs radiation energy in a portion of the electromagnetic spectrum and emits energy in another portion of the electromagnetic spectrum. The emission of energy by the phosphor is sometimes referred to as “fluorescence”.

During operation of the lighting system 100, the organic phosphor layer 137 receives a portion of the light from the light source 104 and emits light that mixes with other portions of the light from the light source 104. In some embodiments, the mixing occurs in the second region 135 of the cavity 130 and results in white light.

For example, in some embodiments, the light source 104 comprises a plurality of BSY LED packages (or a combination of blue LED packages and BSY LED packages) and the organic phosphor layer 137 is an organic red phosphor layer that receives a portion of the light from the light source 104 and emits light that mixes with other portions of the light from the light source 104 to result in white light.

Thus, the color(s) of light produced by the lighting system 100 can be modified by providing an organic phosphor layer 137 on the reflector 120.

The phosphor characteristics of organic phosphor can degrade if exposed to high light levels, such as for example, as may be produced by the light source 104. In accordance with some embodiments, the one or more portions, e.g., portion 138, of the reflector 120 on which the organic phosphor layer 137 is disposed, e.g., portion 138, are remote from the light source 104 and thus do not experience the high light levels that may exist near the light source 104.

In some embodiments, the one or more remote portions, e.g., portion 138, are portions of the reflector 120 that would typically (in the absence of an organic phosphor layer 137) include a reflective coating.

In some embodiments, the one or more remote portions, e.g., portion 138, are located away from (i.e., off) an optical axis 134 and/or radial axis 126. In some embodiments, the one or more remote portions, e.g., portion 138, are located at an angle 150 of greater than 60 degrees from an optical axis 134 and/or radial axis 126. In some embodiments, the one or more remote portions, e.g., portion 138, are located at an angle 150 of greater than 75 degrees from an optical axis 134 and/or radial axis 126.

In some embodiments, the one or more remote portions, e.g., portion 138, are visible from areas, e.g., area 125, illuminated by the lighting system 100.

As a result of disposing the organic phosphor layer 137 on a portion of the reflector 120 that is remote from the light source 104, the organic phosphor layer 137 does not experience the high light levels that exist near the light source 104. This results in cooler operation, less loading and less saturation of the organic phosphor layer 137 compared to if the organic phosphor layer 137 had been located near the light source 104. As a result, the organic phosphor layer 137 retains its phosphor characteristics to a greater degree than if it had been located near the light source 104.

The amount of the organic phosphor that will be needed to achieve any particular effect is greater than would be needed if the organic phosphor layer 137 was located closer to the light source 104 (and thus received higher light levels). However, organic phosphor is significantly lower in cost (in some cases, several orders of magnitude lower in cost) than the non-organic phosphors that are traditionally made use of in LED lighting applications. In view thereof, the overall cost to manufacture the lighting system remains practical.

In some embodiments, the fixture 102 may further include a heatsink and/or other cooling features (e.g., to help prevent converted light and/or heat (from the conversion process) from being directed back to the light source 104).

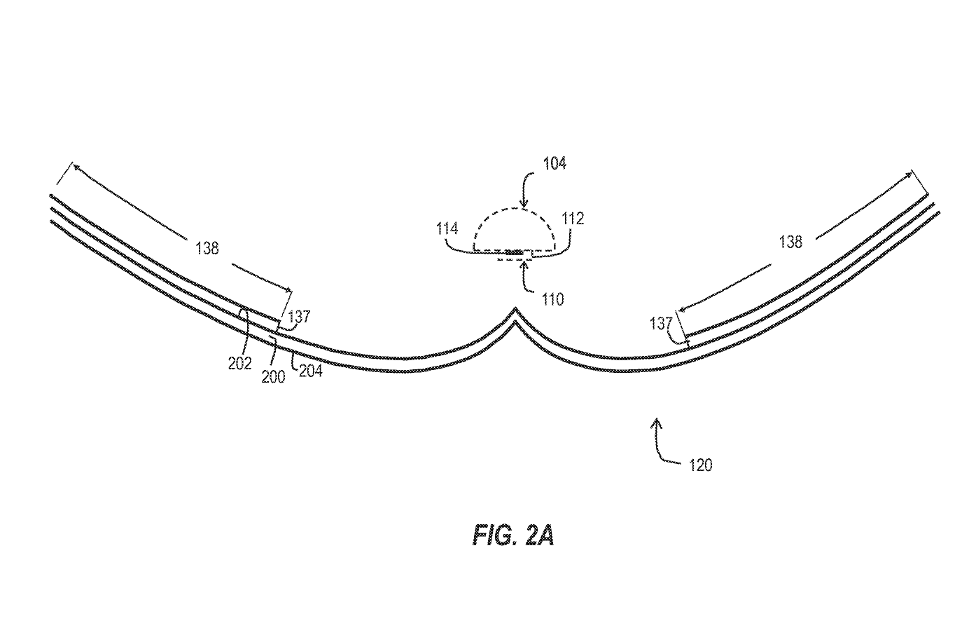

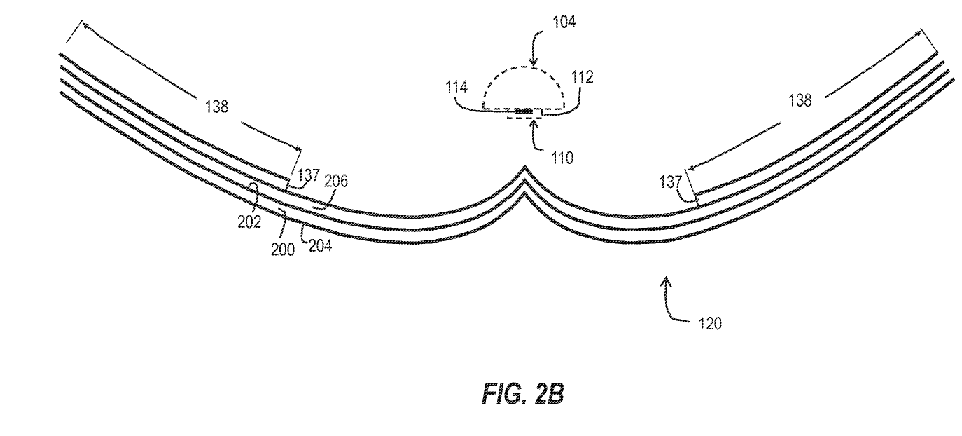

FIG. 2A is an enlarged cross-sectional view of the reflector 120, in accordance with some embodiments. Referring to FIG. 2A, in accordance with some embodiments, the reflector 120 includes a substrate 200 having a first side 202 and a second side 204. The first side 202 is configured to face toward the light source 104. As used herein, the phrase “to face toward” means “to have one or more portions face to at least some degree”. (It should be recognized that all of the portions of the first side 202 that are shown in FIG. 2A face the light source 104 to at least some degree).

An organic phosphor layer 137 is disposed on the first side 202. As used herein, the phrase “disposed on” means “disposed directly on” or “disposed indirectly on”. In FIG. 2A, the organic phosphor layer 137 is disposed directly on the first side 202. FIG. 2B is an enlarged cross-sectional view of the reflector, in accordance with some embodiments, in which the organic phosphor layer 137 is “disposed indirectly on” the substrate 200. In FIG. 2B, an intermediate layer 206 is disposed between the substrate layer 200 and the phosphor layer 137. In some embodiments, the substrate 200 comprises metal, plastic or glass. In some embodiments, the intermediate layer 206 comprises a layer of white or other color paint.

Any suitable method(s) may be used to dispose the organic phosphor layer 137 on the reflector 120. In some embodiments, an organic phosphor slurry is prepared and subsequently applied or otherwise disposed on the first side 202 of the substrate 200. In some embodiments, the organic phosphor slurry is a fluid or a semi-fluid.

In embodiments that include an intermediate layer 206, the intermediate layer 206 may be disposed on the reflector 120 before the organic phosphor slurry is disposed on the reflector 120.

In some embodiments, the organic phosphor slurry is a water-based slurry that is prepared by combining the materials shown in Table 1.

TABLE 1

| MATERIAL | AMOUNT |
|---|---|
| Deionized Water | 35 grams |
| Triton X-100 surfactant | 200 milligrams |
| Fluorescent Pigment | 10 grams |
| 5% Ammonium Polyacrylate Binder | 35 grams |
| Solution | |

In some embodiments, the materials in Table 1 are combined as follows. The deionized water is mixed thoroughly with the Triton X-100 surfactant. The deionized water-Triton X-100 surfactant mixture is then mixed thoroughly with the fluorescent pigment. In some embodiments, the fluorescent pigment comprises DG-13 red manufactured by DAY GLOW. Hot air or other gas is then used to defoam the deionized water-Triton X-100 surfactant-fluorescent pigment mixture, which is then roll mixed with the 5% ammonium polyacrylate binder solution.

In some embodiments, the organic phosphor layer 137 is disposed on the reflector 120 by coating the first side 202 of the substrate 200 with a layer of the organic phosphor slurry. This may comprise brushing the mixture on the first side 202 of the substrate 200, spraying the mixture on the first side 202 of the substrate 200 or dipping the first side 202 of the substrate 200 into the mixture. Spraying the mixture on the first side 202 of the substrate 200 may comprise spraying the mixture on the first side 202 of the substrate 200 using an airbrush spray coating method.

In some embodiments, the organic phosphor slurry is a nitrocellulose/butylacetate based slurry that is prepared by combining the materials shown in Table 2.

TABLE 2

| MATERIAL | AMOUNT |
|---|---|
| Fluorescent Pigment (Thermoset Type) | 1 gram |
| 1% Nitrocellulose Solution (Butyl Acetate | 7.5 grams |
| Solvent) | |
| Butyl Acetate Vehicle/Solvent | 20 grams |

In some embodiments, the materials in Table 2 are combined by stirring the materials together until they are mixed. In some embodiments, the thermoset type of fluorescent pigment comprises a thermoset type of fluorescent red pigment.

In some embodiments, the organic phosphor layer 137 is disposed on the reflector 120 by brushing the mixture on the first side 202 of the substrate 200, by spraying the mixture on the first side 202 of the substrate 200 or by dipping the first side 202 of the substrate 200 into the mixture. Spraying the mixture on the first side 202 of the substrate 200 may comprise spraying the mixture on the first side 202 of the substrate 200 using an airbrush spray coating method.

(1) As used herein, the phrase “organic phosphor layer” means a “layer” that includes organic phosphor. The “layer” may further include one or more additional materials. In some embodiments, the organic phosphor layer 137 comprises one of the following combinations: (1) organic phosphor and reflective material (e.g., materials typically found in a reflective coating on a reflector in an lighting system with an LED light source), (2) organic phosphor and paint (e.g., paint typically found on a reflector in an lighting system with an LED light source) or (3) organic phosphor and matte finish material (e.g., materials typically found in a matte finish coating on a reflector in an lighting system with an LED light source).

In some embodiments, the organic phosphor comprises one or more organic fluorophore and/or chromophore. In some embodiments, the organic phosphor comprises an organic fluorophore that includes: (i) one or more aromatic groups or (ii) one or more cyclic groups with one or more pi bonds.

In some embodiments, the “organic phosphor” may be any organic fluorescent material, and may be in the form of a pigment or a dye. Without being limited by theory, the organic phosphor of embodiments of the present disclosure may function by down-converting blue or UV light to longer wavelengths.

As used herein, a “layer” may or may not have uniform thickness, may or may not be continuous (for example, an etched conductive layer in a printed circuit board will be discontinuous) and may or may not be planar (for example, a conformal layer that is of uniform thickness and disposed on a non-planar surface will be non-planar).

In some embodiments, the organic phosphor layer 137 includes any suitable color(s) and/or amounts of organic phosphor.

In some embodiments, the color(s) and/or amounts of organic phosphor in an organic phosphor layer 137 is selected or otherwise determined based on the color(s) of light produced by the light source 104 and the color(s) of light desired from the lighting system 100.

In some embodiments, a red phosphor may have a peak emission of about 610 to 670 nm (for certain red phosphors, there may be one or more peaks as low as 590 nm); a blue phosphor may have a peak emission of about 440 to 500 nanometers (nm); a green phosphor may have a peak emission of about 500 to 600 nm; a blue-green phosphor may have a peak emission of about 480 to 505 nm.

In some embodiments, the fixture may be fabricated as a single integral component. In some other embodiments, the fixture may be fabricated in two or more pieces that are subsequently assembled together. In some embodiments, the lighting system (or portion(s) thereof) may include additional features (and/or components), and/or fewer features (and/or components), than shown.

In some embodiments, the color of light produced by one light source 104 may differ from the color of light produced by another light source 104 of the same type. This can cause the color of light produced by one lighting system 100 to differ from the color of light produced by another lighting system 100 of the same type. Because many people are able to detect even slight differences in the color of light produced by adjacent lighting systems 100, it is desirable to limit variations in the color of light produced by lighting systems 100 of the same type. Variations in the color of light produced by lighting systems 100 can be reduced by “binning” the light sources (e.g., LED's) used in the lighting systems 100. However, it would be desirable to be able to further reduce the variations and/or to reduce the variations without binning the light sources.

In accordance with some embodiments, the organic phosphor layer 137 disposed in each one of a plurality of lighting systems of a given type may be customized (i.e., determined on a system by system basis), to reduce variations in the color of light produced by the lighting systems 100 of the same type.

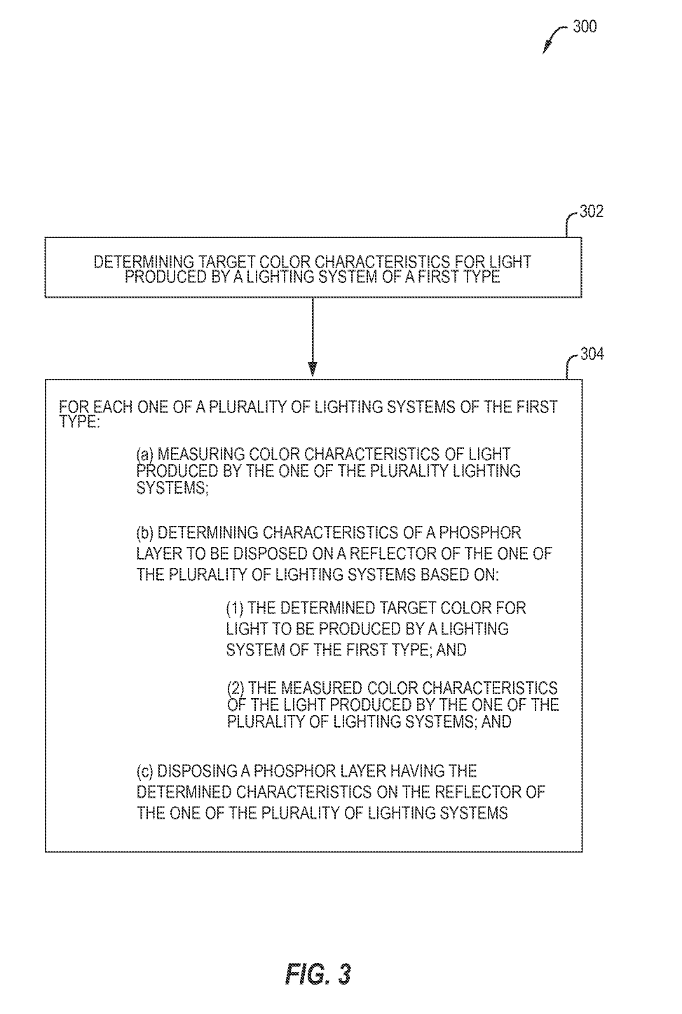

FIG. 3 is a flow chart of a method 300 that may be used in performing the above, in accordance with some embodiments.

Referring to FIG. 3, at 302, the method may include determining target color characteristics for light produced by a lighting system of a first type.

At 304, the method may further include, for each one of a plurality of lighting systems of the first type: (a) measuring color characteristics of light produced by the one of the plurality of lighting systems; (b) determining characteristics of a phosphor layer to be disposed on a reflector of the one of the plurality of lighting systems based on: (1) the determined target color characteristics for light produced by a lighting system of the first type and (2) the measured color characteristics of the light produced by the one of the plurality of lighting systems; and (c) disposing a phosphor layer having the determined characteristics on the reflector of the one of the plurality of lighting systems.

In some embodiments, the determination of the amount (and/or color(s)) of phosphor to be included in a phosphor layer (and/or the providing of the phosphor layer) is part of a final assembly process in the manufacture of the lighting system.

In some embodiments, the method 300 may eliminate any need and/or advantage that may be provided by “binning” of light sources.

In some embodiments, two or more of the organic phosphor layers 137 may be disposed in each of the plurality of lighting systems 100 of the given type. In some of such embodiments, the method 300 may be used in determining the characteristics of each of the organic phosphor layers 137, such that a first organic phosphor layer 137 in each of the plurality of lighting systems 100 represents a “coarse adjust” and a second organic phosphor layer 137 in each of the plurality of lighting systems represents a “fine adjust. In some other embodiments with two or more of the organic phosphor layers 137 in each of the plurality of lighting systems 100 of the given type, the characteristics of phosphor in each first organic phosphor layer 137 may be predetermined and the method 300 may be used in determining the characteristics of each second organic phosphor layer 137. The predetermined characteristics of the first organic phosphor layer 137 in each of the plurality of lighting systems 100 may specify that the first organic phosphor layer 137 in each of the plurality of lighting systems 100 include 90% of the amount that will be needed for the two organic phosphor layers 137.

In accordance with some embodiments, non-organic phosphor (and non-organic phosphor layers) may be used instead of and/or in addition to organic phosphor (and organic phosphor layers). Non-organic phosphor layers may be customized in any of the manners above.

It should be noted that the method 300 is not limited to the order shown in the flow chart. Rather, embodiments of the method 300 may be performed in any order that is practicable. For that matter, unless stated otherwise, any method disclosed herein may be performed in any order that is practicable. Notably, some embodiments may employ one or more portions of a method without one or more other portions of the method.

In some embodiments, a non-transitory computer readable medium may have instructions stored thereon, which if executed by a machine result in performance of the method 300 (or one or more portions thereof).

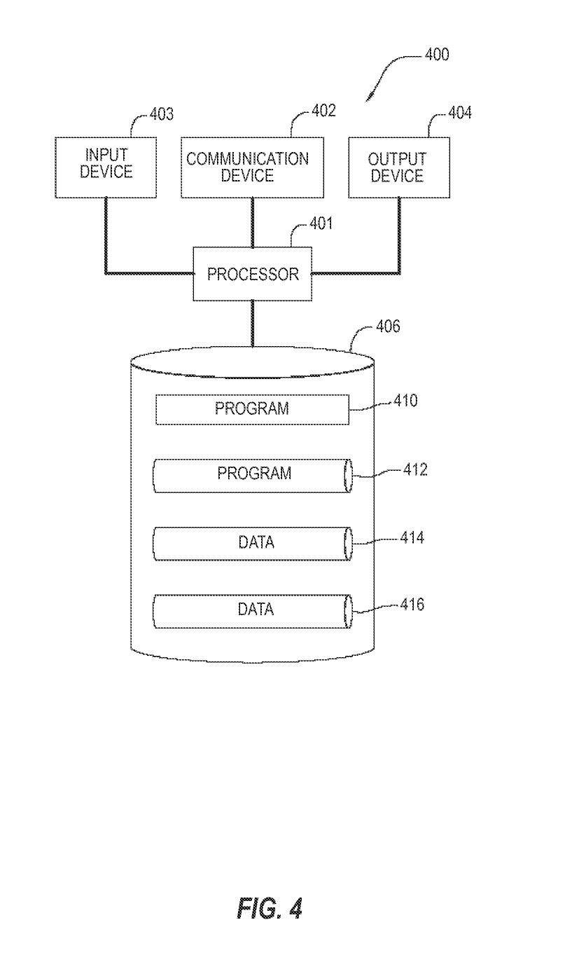

FIG. 4 is a block diagram of an architecture 400 according to some embodiments. In some embodiments, the method 300 (or portion(s) thereof) or one or more other methods disclosed herein (or portion(s) thereof) may be performed by a system having an architecture that is the same as and/or similar to the architecture 400 (or portion(s) thereof).

Referring to FIG. 4, in accordance with some embodiments, the architecture 400 includes a processor 401 operatively coupled to a communication device 402, an input device 403, an output device 404 and a storage device 406, each of which may be distributed or non-distributed.

In some embodiments, the processor 401 may execute processor-executable program code to provide one or more portions of the one or more disclosed herein and/or to carry out one or more portions of one or more embodiments of one or more methods disclosed herein. In some embodiments, the processor 401 may be a conventional microprocessor or microprocessors.

The communication device 402 may be used to facilitate communication with other devices and/or systems. In some embodiments, communication device 402 may be configured with hardware suitable to physically interface with one or more external devices and/or network connections. For example, communication device 402 may comprise an Ethernet connection to a local area network through which architecture 400 may receive and transmit information over the Internet and/or one or more other network(s).

The input device 403 may comprise, for example, one or more devices used to input data and/or other information, such as, for example: a keyboard, a keypad, track ball, touchpad, a mouse or other pointing device, a microphone, knob or a switch, an infra-red (IR) port, etc. The output device 404 may comprise, for example, one or more devices used to output data and/or other information, such as, for example: an IR port, a display, a speaker, and/or a printer, etc.

The storage device 406 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 406 may store one or more programs 410-412 and/or other information for operation of the architecture 400. In some embodiments, the one or more programs 410-412 include one or more instructions to be executed by the processor 401 to provide one or more portions of one or more tasks and/or one or more portions of one or more methods disclosed herein. In some embodiments, the one or more programs 410-412 include one or more operating systems, database management systems, other applications, other information files, etc., for operation of the architecture 400.

The storage device 406 may store one or more databases and/or other information 414-416 for one or more programs. As used herein a “database” may refer to one or more related or unrelated databases. Data and/or other information may be stored in any form. In some embodiments, data and/or other information may be stored in raw, excerpted, summarized and/or analyzed form.

In some embodiments, one or more portions of one or more embodiments disclosed herein may be embodied in a method, an apparatus, a system, a computer program product, and/or an article where the computer program product and/or the article includes a machine readable storage medium with instructions stored thereon. As used herein, a machine may be any type of machine. In some embodiments, a machine comprises a processor. The term “memory” should be understood to encompass a single memory or storage device or two or more memories or storage devices. The term “processor” should be understood to include one processor or two or more cooperating processors. Unless stated otherwise, a processor may comprise any type of processor. For example, a processor may be programmable or non-programmable, general purpose or special purpose, dedicated or non-dedicated, distributed or non-distributed, shared or not shared, and/or any combination thereof. A processor may include, but is not limited to, hardware, software, firmware, and/or any combination thereof. Hardware may include, but is not limited to off the shelf integrated circuits, custom integrated circuits and/or any combination thereof. In some embodiments, a processor comprises a microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. A processor may employ continuous signals, periodically sampled signals, and/or any combination thereof. If a processor is distributed, two or more portions of the control/storage circuitry may communicate with one another through a communication link.

Unless stated otherwise, the terms “on” or “over” do not necessarily mean “on top of” since relative position (above or below) depends on the orientation of the device to the viewer.

In addition, unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A lighting system comprising:
a light source; and
a reflector, the reflector including:
a substrate having a first side configured to face toward the light source; and
an organic phosphor layer disposed on the first side.

2. The lighting system of claim 1, wherein the organic phosphor layer comprises organic red phosphor.

3. The lighting system of claim 2, wherein the light source comprises at least one of a blue LED or a blue shifted yellow LED.

4. The lighting system of claim 1, wherein the organic phosphor layer comprises:
organic phosphor; and
reflective material.

5. The lighting system of claim 1, wherein the organic phosphor layer comprises:
organic phosphor; and
paint or matte finish material.

6. The lighting system of claim 1, wherein the organic phosphor layer is visible from an area illuminated by the lighting system.

7. The lighting system of claim 1, wherein the reflector has a radial axis and the organic phosphor layer is located away from the radial axis.

8. A method of manufacturing a lighting system comprising:
coupling a light source to a reflector, the reflector including a substrate having a first side configured to face toward the light source; and
disposing an organic phosphor layer on the first side of the substrate.

9. The method of claim 8, wherein the organic phosphor layer comprises organic red phosphor.

10. The method of claim 9, wherein the light source comprises at least one of a blue LED or a blue shifted yellow LED.

11. The method of claim 8, wherein the organic phosphor layer comprises:
organic phosphor; and
reflective material.

12. The method of claim 8, wherein the organic phosphor layer comprises:
organic phosphor; and
paint or matte finish material.

13. The method of claim 8, wherein the organic phosphor layer is visible from an area illuminated by the lighting system.

14. The method of claim 8, wherein the reflector has a radial axis and the organic phosphor layer is located away from the radial axis.

15. A method comprising:
determining target color characteristics for light produced by a lighting system of a first type;
for each one of a plurality of lighting systems of the first type:
(a) measuring color characteristics of light produced by the one of the plurality of lighting systems;
(b) determining characteristics of a phosphor layer to be disposed on a reflector of the one of the plurality of lighting systems based on: (1) the determined target color characteristics for light produced by a lighting system of the first type and (2) the measured color characteristics of the light produced by the one of the plurality of lighting systems; and
(c) disposing a phosphor layer having the determined characteristics on the reflector of the one of the plurality of lighting systems.

16. The method of claim 15, wherein the phosphor layer comprises an organic phosphor layer.

17. The method of claim 15, wherein the phosphor layer comprises:
organic phosphor; and
reflective material.

18. The method of claim 15, wherein the phosphor layer comprises:
organic phosphor; and
paint or matte finish material.

19. The method of claim 15, wherein the phosphor layer is visible from an area illuminated by the lighting system.

20. The method of claim 15, wherein the reflector has a radial axis and the phosphor layer is located away from the radial axis.
